(19) United States
(12) Patent Application Publication
(10) Pub. No.: US 2004/0110590 A1
(43) Pub. Date: Jun. 10, 2004

(54) Sprocket

(75) Inventor: Andrew Charles Renshaw, Macclesfield (GB)

Correspondence Address: OLIFF & BERRIDGE, PLC, P.O. BOX 19928, ALEXANDRIA, VA, 22320, US

(73) Assignee: RENTHAL LIMITED, Stockport (GB)

(21) Appl. No.: 10/691,669

(22) Filed: Oct. 24, 2003

(30) Foreign Application Priority Data
Dec. 5, 2002 (GB) 0228344.8

(51) Int. Cl. F16H 55/30

(52) U.S. Cl. 474/152

(57) ABSTRACT

A toothed annulus of steel is attached to the perimeter of an aluminium disc by means of threaded engagement. At least the perimeter edge of the disc and the inner edge of the annulus will usually be of substantially the same thickness.

### FIELD OF THE INVENTION

This invention concerns a sprocket, sometimes known as a chain wheel, for bicycles, motorcycles and similar wheeled vehicles.

### BACKGROUND ART

Sprockets are conventionally formed in one piece as substantially circular discs of steel having teeth around the perimeter, and having various inner sections cut away to reduce weight. Since aluminium is light in weight, and many bicycle and motorcycle parts are made therefrom for this reason, it has recently been proposed to produce a sprocket by attaching a toothed steel annulus around the perimeter of a circular aluminium disc, the steel providing the necessary strength and wear resistance for the toothed perimeter. The aluminium disc and/or the steel annulus is provided with a series of projections or “ears” which overlie the other part and by means of which the parts are rivetted together. This has not proved to be satisfactory as the risk of the steel annulus detaching from the central aluminium disc after a period of use is too great and failure during use could prove fatal.

### OBJECT OF THE INVENTION

An object of this invention is to address this problem.

### SUMMARY OF THE INVENTION

According to the invention a sprocket is provided comprising a disc of a first metal material having a substantially circular perimeter and an externally toothed annulus of a second metal material, which is attached around the perimeter of the disc by the inner edge of the annulus being threadedly engaged with the perimeter edge of the disc.

The term “disc” as used in this specification has the conventional meaning of a flat circular plate, i.e. a wide, thin and generally planar body of circular peripheral shape.

A sprocket according to the invention will usually have a central disc and an outer annulus of substantially the same thickness, generally of the order of from 3 to 10 mm. However, there may be exceptions. For example, the peripheral margin of the disc may be tapered so that the edge is narrower than than a central region of the disc. In such a case only the peripheral edge of the disc may be substantially the same thickness as the annulus; the entire central region, or at least a part of the central region, may be at least a few millemetres thicker than the annulus. Also, in some embodiments the annulus of the sprocket may not itself be of constant thickness. Notwithstanding any such variations in the thickness of the disc or the annulus, or differences between their respective thicknesses, they will still, in most cases, have a minimum thickness of about 3 mm and a maximum thickness of about 10 mm.

Another exception is that the periphery of the disc may be formed with a radially projecting lip, providing a shoulder to which the annulus is threadedly engaged. The periphery of the disc would then be thicker (by the thickness of that lip) than the inner edge of the annulus. The lip need not be continuous. In fact, a series of separate radially projecting ears might be provided at spaced intervals around the periphery of the disc. Alternatively, but less likely, such a lip or ears, and shoulder, may be provided on the inner edge of the annulus.

In practical embodiments of the sprocket of the invention the annulus and the disc may additionally be connected by at least one pin which prevents relative rotation thereof and thereby prevents disengagement of their intermeshed threads.

Additionally or alternatively, adhesive may be applied between the perimeter edge of the disc and the inner edge of the annulus.

In other practical embodiments rivets may also be used to connect the annulus to the disc, for example where one or both are provided with radially projecting ears overlapping the other, as just mentioned.

### BRIEF DESCRIPTION OF THE DRAWING

The invention will be described further, by way of example, with reference to the accompanying drawing, in which:

FIG. 1 is a side view of a practical embodiment of a sprocket in accordance with the invention; and

FIG. 2 is a cross-section along line II-II in FIG. 1, but showing five variations in thread size.

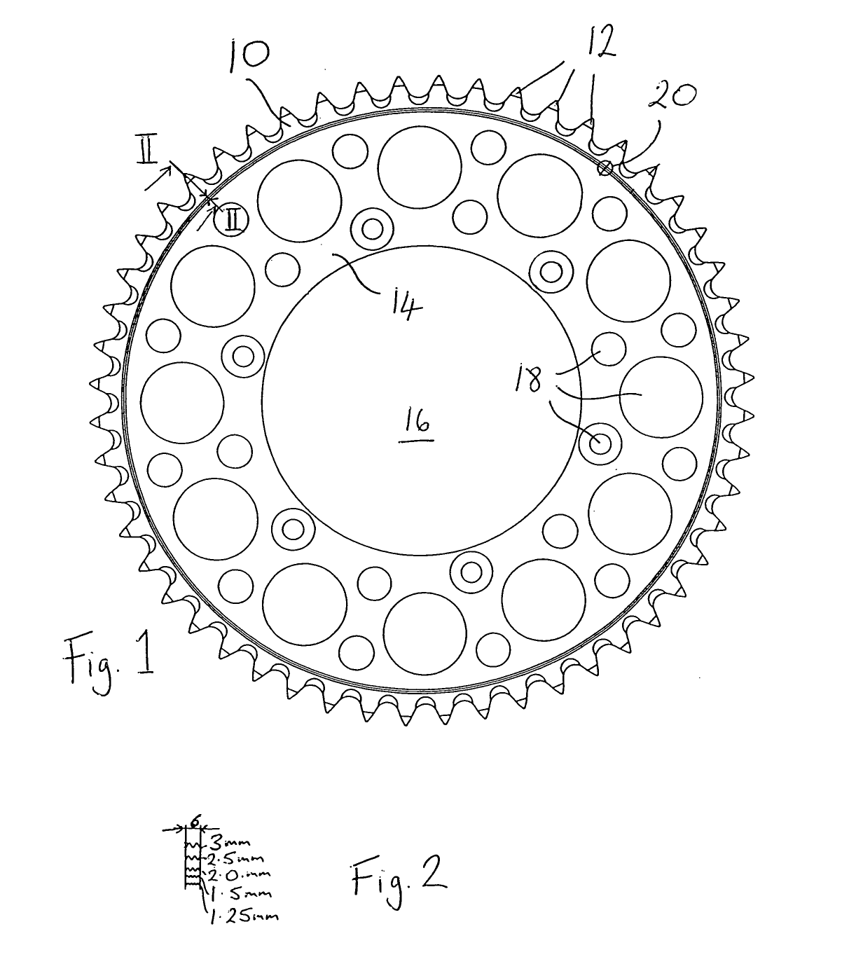

### DETAILED DESCRIPTION OF ILLUSTRATED EMBODIMENT

The exemplary sprocket comprises an annulus 10 of steel having conventionally formed teeth 12 around its outer edge. The inner diameter of this annulus 10 may be about 122 mm. The sprocket further comprises a disc 14 of aluminium or an aluminium alloy which has an outer circular perimeter about 120 mm in diameter. A large circular central aperture 16 is cut out of the disc 14, so it is also annular. A number of other circular apertures 18 are cut out of the disc 14, as is customary, to reduce weight, while also creating an attractive pattern for the sprocket.

The steel annulus 10 is connected to the perimeter of the aluminium disc 14 by threaded interengagement. With reference to FIG. 2, the disc and the annulus are both 6 mm thick in this example. The outer edge of the disc 14 and the inner edge of the annulus 10 are formed with corresponding i.e. engagable, helical grooves to accomplish said threaded engagement. With a 6 mm thickness, the number of helical turns may suitably be from 2 to 6, so that each thread has a thickness (pitch) between 3 mm and 1 mm. FIG. 2 shows possible variants having 2, 2.5, 3, 4 and 5 helical turns. Obviously both the disc 14 and the annulus 10 must be formed with great precision so that a secure threaded engagement is accomplished.

Adhesive may also be used to secure the threaded connections between the outer annulus 10 and the central disc 14.

Finally, after the annulus 10 is threadedly connected to the disc 14, a single pin 20 is inserted across the line of the connection at one location to prevent any risk of the disc 14 disengaging.

The disc pattern and the dimensions may, of course, vary in other embodiments within the scope of the invention.

1. A sprocket comprising a disc of a first metal material having a substantially circular perimeter and an externally toothed annulus of a second metal material which is attached around the perimeter of the disc by the inner edge of the annulus being threadedly engaged with the perimeter edge of the disc.

2. A sprocket as claimed in claim 1 wherein the disc and the annulus are of substantially the same thickness.

3. A sprocket as claimed in claim 1 wherein the perimeter edge of the disc and the inner edge of the annulus are of substantially the same thickness.

4. A sprocket as claimed in claim 1 wherein the thickness of the disc is in the range from 3 mm to 10 mm.

5. A sprocket as claimed in claim 1 wherein the thickness of the annulus is in the range from 3 mm to 10 mm.

6. A sprocket as claimed in claim 1 wherein the annulus and the disc are additionally connected by at least one pin which prevents relative rotation thereof.

7. A sprocket as claimed in claim 1 wherein the annulus and the disc are additionally connected by adhesive applied between the perimeter edge of the disc and the inner edge of the annulus.

8. A sprocket as claimed in claim 1 wherein the perimeter edge of the disc and the inner edge of the annulus are each formed with from two to six turns of interengaging helical threads.
